(19) United States
(12) Patent Application Publication
(10) Pub. No.: US 2026/0006167 A1
(43) Pub. Date: Jan. 1, 2026

(54) MEASURING DEVICE BASED ON A COMBINATION OF OPTICAL 2D AND 3D IMAGE CAPTURING METHODS

(71) Applicant: BESI SWITZERLAND AG, Steinhausen (CH)

(72) Inventors: Norbert BILEWICZ, Steinhausen (CH); Markus GRIESSHAMMER, Steinhausen (CH)

(21) Appl. No.: 18/852,449

(22) PCT Filed: Apr. 3, 2023
(86) PCT No.: PCT/IB2023/053349

§ 371 Date: May 9, 2025

(30) Foreign Application Priority Data
Apr. 1, 2022 (DE) 10 2022 107 897.3

(51) Int. Cl. H04N 13/286; B25J 15/00; H04N 23/45

(52) U.S. Cl. CPC H04N 13/286; H04N 23/45; B25J 15/00

(57) ABSTRACT

Measurement apparatus (100, 101, 102) that is also suitable for a manufacturing or inspection system, comprising a light source (500) for emitting an illumination light beam (520) and a reference light beam (510), an imaging lens (800) that directs measurement light (530) and reference light (510) onto a 2 D image sensor (200) and a 3D image sensor (300), wherein the measurement apparatus (100) is configured to substantially reduce the intensity of the reference light (510) incident on the 2D image sensor (200) if it is operating in a 2D imaging mode.

### TECHNICAL FIELD

The present disclosure relates to a measurement apparatus based on combined optical 2D and 3D image capture methods. It is further related to a manufacturing system and an inspection system, each with such a measurement apparatus.

### STATE OF THE ART

Various optical technologies for 3D image capture methods are used in industry because of their contactless and non-destructive measurement properties.

Inline-capable measuring methods are thereby preferred for inspection purposes, due to the larger percentage of objects to be inspected and the possibility of taking quick countermeasures when the system states that, for example, an error in the form of a defect or a deviation from a nominal size has occurred. Such countermeasures include, for example, the control of setting variables, such as the pressure in the dispensing processes of (epoxy) adhesives.

Some manufacturing systems, such as semiconductor pick-and-place systems, require machine-based image processing for high throughput with an associated high degree of accuracy in the placement of components.

These technologies include point/profile measurements such as laser line triangulation, confocal scanning and imaging methods such as light field cameras, fringe projection, structured light projection or focus variation, as well as time-of-flight cameras (TOF), white light interferometry and parallel optical coherence tomography (pOCT).

Point/profile measurements typically use lateral scanning to generate a height map of a required area, but this can be too slow for inline measurements, and accuracy can be reduced due to problems such as shadowing behind edges. Typically, the required area is the optical field of view of the imaging optics.

‘Inline’ in this context as well as in the context of the entire invention disclosure means both “within a manufacturing process” and/or “integrated in a manufacturing system”.

Imaging methods can be used to directly measure individual areas within an optical field of view or several optical fields of view, or to capture measured values of them. Different axial and lateral (transversal) resolutions can be used—in particular, the axial resolution can influence the accuracy of height measurements. Light field cameras and time-of-flight cameras usually offer axial resolutions of only about 0.1 mm. A focusing variation with higher axial resolutions may require relatively small working distances (a few millimeters or less) due to the coupling between the axial and vertical resolutions. The process of so-called fringe projection also requires a relatively large assembly volume due to a projector required for the projection together with two inclined cameras.

While white-light interferometry is capable of sub-micrometer axial resolution and high-speed smart pixel sensors are commercially available that can be configured to provide a height map of a 3D point cloud within about 300 ms. However, the lateral resolution of such an image sensor is severely limited by the possible number of pixels of about 280×292 or about 512×560 pixels.

Detailed examples of such apparatus are known from US 2011/0317169 A1 or JP 2016-102713 A, which describe devices for capturing an interference-free image of a measurement object. In addition, methods for creating an image free of interference fringes are well known from US 2003/0 197 871 A1 or U.S. Pat. No. 9,719,777 B1, but also without influencing the reference beam path.

### TECHNICAL PROBLEM

It is the object of the invention to provide a measurement apparatus for inline measurements that, despite a high measurement speed to achieve a high throughput, enables a high image resolution and the measurement accuracy that can be derived from it, and despite this high requirement is still compact and can therefore be produced cost-effectively.

### DESCRIPTION OF THE INVENTION

A measurement apparatus is provided for the solution, which comprises a light source for emitting an illumination light beam and a reference light beam, and an imaging lens that directs measurement light and reference light onto at least one 2D image sensor and at least one 3D imaging sensor. The measurement apparatus is thereby configured to substantially reduce the intensity of reference light incident on the 2D image sensor when operating in a 2D image capture mode.

By using an optical setup in which at least the aforementioned optical components are suitable as well for 2D image capture as for 3D image capture, a smaller assembly volume can be used for all embodiments of a measurement apparatus. The advantage of this is that the optical design can be accommodated in just one housing, even though it has several optical paths for both 2D image capture and 3D image capture. Furthermore, a smaller measurement apparatus can lead to a more compact consideration of the manufacturing or inspection system. This has the advantage that shorter path lengths are possible for moving axes of each system, which in turn results in higher productivity.

This also reduces mechanically induced interference, such as tolerance-related deviations or component misalignment, which leads to optimally harmonised measurement results from the sensors due to a setup-related reduced offset.

Using the same light source and, to a substantial degree, the same optical elements not only reduces the amount of work involved in assembly and the costs for components and production, but also has the positive effect of using the same light properties, such as illumination or light intensity, for additional coordination of the measurement results with each other, which also leads to a better comparability and reproducibility of the measurement results.

Additionally, the use of the same light source and substantially the same optical elements makes it possible to switch between 2D image capture and 3D image capture faster than is the case with conventional systems within a pre-set time, which is highly advantageous for inline measurement.

The advantage is that data for machine-based image processing is provided for the capture of high-resolution images, which, in addition to the derivable measurement accuracy, also has a high measurement speed in both the lateral and axial directions, with a high throughput and the associated highly accurate and fast placement of components, wherein setup-related measurement errors of the measurement apparatus itself are reduced to a minimum.

“Inline” means both “within a manufacturing process” and/or “integrated into a manufacturing system” in the context of the overall disclosure of the invention.

According to one aspect, the technical problem is solved by a measurement apparatus comprising a first image sensor for 2D image capture and a second image sensor for 3D image capture, wherein the measurement apparatus is configured and arranged to be focussed on a common region of an object wherein the measurement apparatus comprises a light source configured and arranged to, in use, emit an illumination light beam onto the common region, and the light source is also configured and arranged to emit a reference light beam onto the second image sensor. In addition, a measurement apparatus comprises an imaging lens that comprises at least one optical element and is arranged such that, in use, light that is reflected by the common region as light to be measured in the form of a measurement light beam enters the imaging lens together with the reference light beam from the light source. The imaging lens is formed and arranged to direct and focus at least a portion of the measurement light beam onto the first image sensor and onto the second image sensor and to direct and focus at least a portion of the reference light beam onto the second image sensor. In addition, the measurement apparatus is formed and arranged to reduce the intensity of the reference light beam received at the first image sensor relative to the intensity of the measurement light beam when the measurement apparatus is operated in a 2D image capture mode.

The measurement apparatus combines 2D image capture and 3D image capture in a single optical setup, using the same illumination optics and the same imaging optics.

The measurement apparatus thus retains the advantages of an optical measurement, such as contactless and/or non-destructive measuring. Furthermore, in 2D image capture, data for images with relatively high lateral resolution, namely in the micrometre range and below, is captured and made available, and in 3D image capture, data for images with relatively high axial resolution, namely in the micrometre range, is captured and made available, preferably for capturing 3D contour maps.

By significantly suppressing the reference light beam that reaches the first image sensor during operation in 2D image capture mode, the dynamic measuring range can be increased and both the accuracy of 2D image capture and the accuracy of the measurement results of combined 2D and 3D image capture can be improved.

In addition, using the same optical setup for both 2D image capture and 3D image capture can enable a smaller overall size, allowing for a variety of integration possibilities in manufacturing systems. It can also lower the average production price of such measurement apparatus by reducing the number of components required.

Additionally, the measurement apparatus can be configured and arranged to quickly switch between a 2D image capture mode and a 3D image capture mode, which is highly advantageous for inline measurements due to the timesavings.

Embodiments of a measurement apparatus comprise image capture sensors that are specifically designed for 2D image capture or 3D image capture. Any suitable image sensors can be used for this, if they can provide suitable data in the 2D image capture mode or in the 3D image capture mode. In some cases, it may be possible to use an image sensor designed for 3D image capture in a 2D image capture mode. Practice has shown that it is particularly advantageous if the first image sensor is a 2D image sensor and the second image sensor is a 3D image sensor, or if the first image sensor is also a 3D image sensor but is formed and arranged such that it can be operated in 2D image capture mode.

Embodiments of a measurement apparatus comprise a second image sensor that is suitable for white light interferometric imaging for the capture of the 3D height maps with relatively high axial resolution as part of the 3D image capture.

Embodiments of a measurement apparatus are further formed and arranged such that a significant portion of the reference light beam is transmissible from the imaging lens toward the second image sensor if operating in a 3D image capture mode, wherein the measurement apparatus may additionally comprise a first light divider formed and arranged to receive the measurement light beam from the imaging lens.

Additionally, such embodiments of a measurement apparatus can also be formed in such a way that a first portion of the measurement light beam can be directed onto the first image sensor and/or a second portion of the measurement light beam can be directed onto the second image sensor.

It can be advantageous to provide a higher quantity of shared optical elements for each optical path.

In particular, space may be limited near the image sensors for further actuators, so that it may be possible to reduce the size of the measurement apparatus within the assembly volume if these sensors are not used.

In addition, the reduction in the need for elements that can significantly alter or disrupt the optical paths to the image sensors can allow for higher switching rates between modes if measurement interference and/or settling times are reduced.

Additionally, it is preferable that the same common region be captured for both the 3D images and the 2D images, i.e. that the 3D images and the 2D images show the same optical field of view and at only have slight deviations in the field of view depicted in the images. This may be due, for example, to a slight shift in the optical field of view during the capture. This can allow for both higher switching rates between a 2D image capture mode and a 3D image capture mode and a higher measurement accuracy, in particular for a volume measurement, since there is no axis displacement between the two image captures, i.e. a mechanical process along a movement axis of the setup.

Embodiments of a measurement apparatus are further formed and arranged such that the intensity of the reference light beam is reducible along the optical path of the reference light beam. Advantageously, the reduction of intensity is accomplished between the imaging lens and the light source, between the first or second light divider and the image sensors, or the reduction of intensity is accomplishable in the light source itself.

By reducing the intensity near the source of the reference light beam, an even higher quantity of common optical elements can be provided for each optical path. In particular, the optical path for measurements in either 2D image capture mode or 3D image capture mode is substantially the same. This can additionally reduce measurement interference and/or settling times. In addition or as an alternative, a measurement apparatus with an even smaller assembly volume can be provided.

This can be advantageous because relatively fast measurements can be performed due to the higher speed for simplified switching. For example, greater than or equal to 1 Hz, which is particularly advantageous for inline measurements.

Embodiments of a measurement apparatus comprising a beam intensity reducer in form of one or more of the following elements, namely one or more apertures, one or more shutters, one or more mechanical irises, one or more mirrors, one or more dichroic mirrors, one or more dielectric mirrors, one or more prisms, one or more corner cubes, one or more beam splitters, one or more lens elements, one or more coatings, one or more optical filters, one or more compensation plates and/or any combination thereof, as an additional element or elements, which is or are formed and arranged such that the intensity of the reference light beam received by the first image sensor can be substantially reduced in operation in 2D image capture mode.

Embodiments of a measurement apparatus include a first light divider that is formed and arranged so that the measurement light beam can be received by the imaging lens and so that a first portion of the measurement light beam can be directed onto the first image sensor and/or a second portion of the measurement light beam can be directed onto the second image sensor.

In these embodiments of a measurement apparatus, the first light divider is preferably formed and arranged so that, in operation in a 3D image capture mode, the reference light beam can be received by the imaging lens and at least a portion of the reference light beam can be transmitted in the direction of the second image capture sensor.

Furthermore, in preferred embodiments of a measurement apparatus, the first light divider comprises one or more of the following: a mirror, a dichroic mirror, a dielectric mirror, a prism, a corner cube, a beam splitter, an optical element, a coating, an optical filter, a compensation plate, and/or any combination thereof.

Furthermore, embodiments of a measurement apparatus include an imaging lens comprising one or more compound lenses, wherein the imaging lens is preferably a telecentric imaging lens with object-side, image-side or both-side telecentrics.

Preferably, embodiments of a measurement apparatus are formed and arranged to provide one or more fields of view of the common region of the object.

Embodiments of a measurement apparatus further include a second light divider that is formed and arranged so that, in operation in a 3D image capture mode, an incident light beam from the light source is receivable and at least a portion of the incident light beam is directable as an illumination light beam onto the common region and at least a portion of the incident light is directable as a reference light beam onto the imaging lens.

It can be advantageous to provide an even higher quantity of shared optical elements for each optical path. This leads to a reduction in interference, in particular during mode switching.

Embodiments of a measurement apparatus are configured and arranged to be operable in a 3D image capture mode such as white light interferometry, optical coherence tomography (OCT), parallel optical coherence tomography (pOCT), or any combination thereof.

With all these and other possible embodiments of a measurement apparatus, it is possible, based on the combined optical 2D image capture and 3D image capture, to carry out the determination of volumes of surface-dispensed media based on the measurement data captured by means of 2D image capture in the lateral direction and based on the measurement data captured by means of 3D image capture in the lateral direction axial direction.

With all these and other possible embodiments of a measurement apparatus, it is possible, due to the combined optical 2D image capture and 3D image capture, to carry out topological surface measurements as well as roughness measurements of larger or coherent surfaces based on the measurement data captured by means of 2D image capture in the lateral direction and by means of 3D image capture in the lateral direction axial direction.

According to a further aspect, a manufacturing system is provided for sorting objects and/or for placing an object on a substrate, which system comprises an image capture system having one or more measurement apparatuses and at least one placement head, each having at least one tool to uphold the object in a releasable manner, a robot system for creating a relative movement between the pick-and-place head and the substrate, and an image capture system for capturing one or more common regions of an object to be captured.

According to a further aspect, an inspection system is provided which comprises an image capture system with one or more measurement apparatus for capturing one or more fields of view of an object to be inspected, as well as a processor which is formed and arranged such that it derives one or more measurement values of the object to be inspected from the one or more fields of view. Furthermore, the processor can be used to determine from the one or more measured values whether a fault in the form of a defect or a deviation from a nominal value has occurred in the object to be inspected.

The particular embodiment of these aspects as a placement or inspection system, comprising an embodiment of the previously described measurement apparatus, has the advantage that the use of a measurement apparatus with a reduced assembly volume and high switching speeds allows for the use of inline measurements in the production of components and/or assemblies, not only in the field of semiconductor devices, but also for any type of component and/or assembly.

In some cases, in which the image capture system, comprising one or more measurement apparatus, is to be moved, a lower weight due to a lower number of components can also be advantageous.

### SHORT DESCRIPTION OF THE FIGURES

Further advantages and features of the invention result from the following figures and the detailed description, namely

FIG. 1A shows schematically a measurement apparatus setup in 2D image capture mode;

FIG. 1B shows schematically a measurement apparatus setup in 3D image capture mode;

FIG. 2A shows schematically a section of the measurement apparatus setup in 2D image capture mode;

FIG. 2B shows schematically a section of the structure of a measurement apparatus in the 3D image capture mode;

FIG. 3A shows a plan view of the structure of a measurement apparatus in the 2D image capture mode; and

FIG. 3B shows a top view of the structure of a measurement apparatus in the 3D image capture mode.

### DETAILED DESCRIPTION

In the following detailed description, numerous non-limiting specific details are given for better understanding.

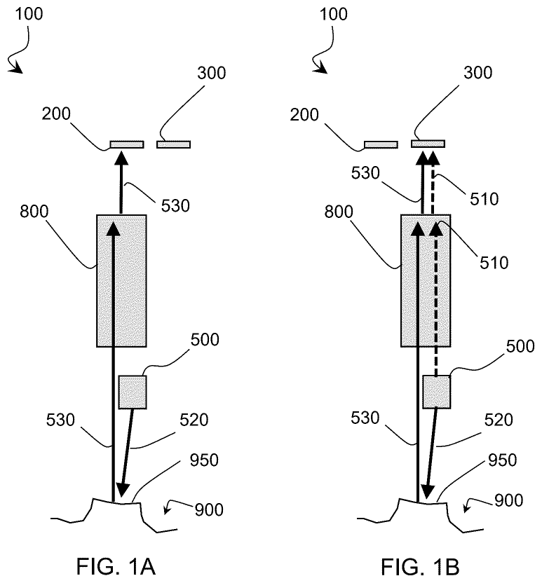

FIG. 1A and FIG. 1B each show schematically a setup of an embodiment of a measurement apparatus, here as measurement apparatus 100, which operates in a 2D image capture mode as depicted in FIG. 1A and in a 3D image capture mode as depicted in FIG. 1B, respectively. The measurement apparatus 100 is configured and arranged to be focused on an object 900, such as a component, to

capture a 2D image or a 3D image of a common region 950 of the object 900. The measurement apparatus 100 comprises at least the two photosensitive elements schematically indicated in the form of the two imaging sensors 200, 300. An arrangement of photodiodes or a so-called ‘position sensitive device’, also referred to as a PSD chip, has proven to be a preferred photosensitive element for use as an image sensor. The use of a CCD photodetector or a CMOS photodetector has thereby also proven to be advantageous.

Preferably, in embodiments of the measurement apparatus, both image sensors are differently constructed, such that one imaging sensor is constructed as an array of photodiodes or as a so-called ‘position sensitive device’ or PSD chip and the second image sensor is constructed as a CCD photodetector or as a CMOS photodetector.

In embodiments of the measurement apparatus, both imaging sensors may also be of the same type and each may be an array of photodiodes or a position-sensitive device (PSD) chip or each may be a charge-coupled device (CCD) photodetector or a complementary metal-oxide-semiconductor (CMOS) photodetector.

In particular, the measurement apparatus 100 comprises a first image sensor 200 that is suitable for 2D image capture, e.g. a relatively high-resolution black-and-white or colour image sensor. Such an image sensor for 2D image capture, also referred to as a 2D image sensor, allows the measurement apparatus to capture an image based on data from the common region 950 of an object depth plane that was in focus at the time of measurement. Such an image sensor also allows for lateral measurements, i.e. measurements across the field of view, at an axial position along an axis of an illumination light beam 520 or along the Z-axis of a Cartesian coordinate system, wherein the X-axis and the Y-axis span a plane in which the common region 950 adjoins. The field of view of the measurement apparatus 100 is approximately perpendicular to the axis of the illumination light beam 520, wherein tests have shown that small angle deviations of up to 0.75° are tolerable.

Furthermore, the measurement apparatus 100 also comprises a second image sensor 300 that is suitable for 3D image capture. Such an image sensor for 3D image capture, also referred to as a 3D image sensor, allows for the measurement apparatus to capture data of surface textures and to provide it in the form of a 3D point cloud. For example, an image sensor comprising multiple pixels is suitable for this purpose, with which such a 3D point cloud can be generated. The height information is generated from an image sequence based on white light interferometry, optical coherence tomography (OCT), parallel optical coherence tomography (pOCT) or any combination thereof.

A suitable 3D image sensor preferably has a lateral resolution of at least 280×292 pixels using process detectors with pinned photodiodes. The row and column spacings are preferably 40 micrometres (μm) or less, and the quantum efficiency η is ideally 20-60% between 330 and 400 0 nm, preferably 60-80% between 400 nanometres (nm) and 720 nm, and particularly preferably 60-20% between 720 nm and 900 nm. Ideally, a particularly suitable 3D image sensor can capture and process more than 1 million images per second.

The measurement apparatus 100 further comprises a light source 500 configured and arranged to emit, in use, an illumination light beam 520 towards the common region 950. The illumination light beam 520 is illustrated as a solid arrow. Preferably, the light source 500 is a low-coherent light source 500, such as an LED. For example, an LED light source with a wavelength of 650 nm and a bandwidth of +/−20 nm. Low-coherent sources are those whose spectral width (full width at half maximum half-width (FWHM)) exceeds 1% of the mean wavelength.

Furthermore, the light source 500 is configured and arranged to emit a reference light beam 510 towards the second image sensor 300. This is not illustrated in FIG. 1A because the reference light beam 510 is significantly reduced in intensity when the measurement apparatus 100 is operating in 2D image capture mode. In FIG. 1B, the reference light beam 510 is illustrated as a dashed line arrow because the reference light beam 510 is used if the measuring device 100 is operating in the 3D image capture mode.

The measurement apparatus 100 further comprises an imaging lens 800, comprising at least one optical element, preferably an imaging lens, arranged such that, in use, light reflected from the common region 950 as a measurement light beam 530 and the reference light beam 510 from the light source 500 enter the imaging lens 800 together as light 540. The imaging lens 800 preferably comprises one or more compound lenses. In addition, the imaging lens 800 can be a telecentric lens with object-side, image-side or double-sided telecentrics. This makes it possible to reduce magnification changes if the axial distance in the vertical direction along the Z-axis to the object changes.

The imaging lens 800 is configured and arranged to direct and focus at least a portion of the measurement light beam 530 onto the first image sensor 200 and onto the second image sensor 300; and to direct and focus at least a portion of the reference light beam 510 onto the second image sensor 300.

Furthermore, the measurement apparatus 100 is configured and arranged such that the intensity of the reference light beam 510 received at the first imaging sensor 200 is substantially reduced if it is operated in the 2D image capture mode of FIG. 1A.

During operation in a 3D image mode, as illustrated in FIG. 1B, the illumination light beam 520 captured by the light source 500, represented as a solid arrow, is emitted in the direction of the object 900 and focused (not shown in FIG. 1) on the common region 950. At least a portion of the illumination light beam 520 is reflected from the common region 950, which is reflective or optically transmissive in the light emitted from the light source 500.

After the measurement light beam 530 has been reflected by the object 900, the reflected measurement light beam 530, illustrated by a solid arrow, enters the imaging lens 800, which directs the measurement light beam 530 onto the second image sensor 300 and focuses it.

The reference light beam 510 captured by the light source 500, illustrated as a dashed line arrow, is emitted in the direction of the imaging lens 800, which directs and focuses the reference light beam 510 onto the second image sensor 300.

The second image sensor 300 is configured and arranged to receive the measurement light beam 530 and the reference light beam 510 from the imaging lens 800 and to combine the measurement light beam 530 and the reference light beam 510 on the second image sensor 300.

The setup shown in FIG. 1A operated in 2D image capture mode is the same as the setup shown in FIG. 1B operated in 3D image capture mode, except for the first image sensor 200. The first image sensor 200 is configured and arranged in FIG. 1A to receive the measurement light beam 530 and the reference light beam 510 from the imaging lens 800 instead of the second image sensor 300 in FIG. 1B. As schematically illustrated, the measurement apparatus 100 is configured and arranged such that the first image sensor 200 is arranged in line with the exit beam of the imaging lens 800. The first image sensor 200 and the second image sensor 300 can be contained, for example, in a suitably configured linear exchange head, a suitably configured rotatable turret or similar. Furthermore, the measurement apparatus 100 is configured and arranged so that the intensity of the reference light beam 510 received at the first image sensor 200 is substantially reduced.

In the context of the disclosure, for this and all further embodiments, ‘substantially reducing’ means reducing the intensity of the reference light beam 510 received at the first image sensor 200 by at least 80%, or preferably by at least 90%, or also by reduction of 95% and particularly preferably a reduction of at least 98% to 99% compared to the reference light beam 510 reaching the second image sensor 300 in the 3D image capture mode, or the reference light beam 510 can be extinguished.

Such a reduction can preferably be achieved by one or more software controls that change one or more operating parameters of the light source 500 accordingly.

However, such a reduction can also be achieved by means of a beam intensity reducer 700 or several mechanical elements for beam intensity reduction, which block at least a portion of the reference light beam 510 between the light source 500 and the first image sensor 200, such as a shutter and/or an mechanical iris and/or a mirror and/or a dichroic mirror and/or a dielectric mirror and/or a prism and/or a corner cube and/or a beam splitter and/or a lens element and/or a coating and/or an optical filter and/or a compensation plate. A person skilled in the art may also consider one or more optical elements that deflect at least a portion of the reference light beam 510 from its optical path for 3D image capture between the light source 500 and the first image capture sensor 200, such as a mirror, a dichroic mirror, a dielectric mirror, a prism, a corner cube or a beam splitter. The person of skill in the art may also consider one or more optical elements that change one or more optical properties of at least a portion of the reference light beam 510 between the light source 500 and the first image sensor 200, such as a lens element, a coating, an optical filter, or a compensating plate, and/or any combination thereof. For example, the beam intensity reducer 700 can be modified to be highly optically absorbing of the light emitted by the light source 500.

In this embodiment, the above-mentioned means for substantially reducing the intensity can be included in the first image sensor 200, arranged between the first image sensor 200 and the imaging lens 80 0, included in the imaging lens 800, placed between the imaging lens 800 and the light source 500, included in the light source 500, or any combination of the foregoing.

Preferably, the above mentioned means are mainly employed at locations along the optical path between the imaging lens 800 and the light source 500 and/or contained in the light source 500, since this increases the portion of the common optical path that is used in both the 2D image capture mode and the 3D image capture mode. This can allow for a high degree of component integration, which can reduce the assembly volume of the measurement apparatus 101. This can ultimately also result in lower manufacturing costs due to a smaller number of components.

One of the insights on which the invention is based is that many conventional measurement apparatuses for 2D image capture or 3D image capture allow for a significant portion of the reference light beam to be directed onto the 2D image sensor or to be incident on it. The inventors have recognised that in some configurations this can increase the total intensity of the light striking the 2D image sensor, causing an offset in the measurements that can effectively reduce the dynamic range during measurements in 2D image capture mode. In addition or as an alternative, in some configurations, this interference from the reference light beam can disturb the image and affect the measurement result, in particular the accuracy of the measurement. By significantly suppressing the reference light beam 510 that reaches the first image sensor 200 during the 2D image capture, both the dynamic range and the accuracy of the 2D image capture and the dynamic range and the accuracy of the results of the combined 2D image capture and 3D image capture can be improved.

In addition, the measurement apparatus 100 can be configured and arranged to quickly switch between 2D image capture mode and 3D image capture mode, which is very advantageous for inline measurements.

The measurement apparatus 100 is also configured and arranged to image a variety of axial positions (also referred to as axial or Z-scan) during the 3D image capture process. This can be accomplished, for example, by moving the object 900 axially toward and/or away from the exit opening of the measurement apparatus 100. This may also be accomplished, for example, by displacing one or more optical elements that intersect at least a portion of the reference light beam 510, the illumination light beam 520, the measurement light beam 530, or any combination thereof. This can also be accomplished, for example, by changing one or more optical properties of an element that intersect at least a portion of the reference light beam 510, the illumination light beam 520, the measurement light beam 530, or any combination thereof. This can also be accomplished, for example, by any combination thereof, namely by moving axially and/or by shifting and/or by changing.

During the axial or Z-scan, images are continuously captured by the 3D (second) image sensor 300.

During the 2D image capture, one or more images can be captured with the 2D (first) image sensor 200 at a fixed axial position. The captured image of the common region 950 is therefore determined by the nominally focused field of view and adjacent axial positions, which are also focused due to the depth of field (DOF) of the measurement apparatus 100.

Preferably, the device is configured and arranged so that a 3D image capture by means of parallel optical coherence tomography (pOCT) is possible. pOCT is based on imaging white light interferometry and typically provides axial resolution in the sub-micrometer range. As described below, the light beam emerging from the light source 500 is preferably divided into an illumination light beam 520 and a reference light beam 510. After the measurement light beam 530 has been reflected by the object 900, the reflected measurement light beam 530 and the reference light beam 510 arrive together at the second image sensor 300. Thereby, each individual difference in the time of flight of the light is measured due to the different lengths of the optical path of the common region 950, which is caused by surface topology. This modulates the interference signal on the second image sensor 300 and is laterally resolved by the sensor pixels.

The height map of the common region 950 can then be derived from this difference in the time of flight of the light. Each pixel provides a modulated signal with a decaying envelope—the signal is maximal if the length of the optical path or the resulting time-of-flight difference of the reference light beam 510 and the sample light beam (the illumination light beam 520+the measurement light beam 530) are the same. The corresponding common region 950 height can be determined from this.

For example, with a smart pixel sensor-based camera setup, a series of images can be captured at several axial positions at kHz frequencies and processed using embedded electronics. A 3D height map can then be provided within about 300 ms. Compared to conventional point/profile measurements, no time-consuming lateral scanning is required.

The limited lateral resolution of a smart pixel sensor, typically around 280×292 pixels, can be at least partially compensated by a combined measurement with a high lateral resolution, such as a twelve-megapixel 2D image sensor with 3000×4000 pixels.

Further details on the pOCT-based measurement procedure can be found in ‘Parallel Optical Coherence Tomography (pOCT) for Industrial 3D Inspection’, Patrick Lambelet, ‘Optical Measurement Systems for Industrial Inspection VII’, Proc. of SPIE Vol. 10.1117/12.889390.

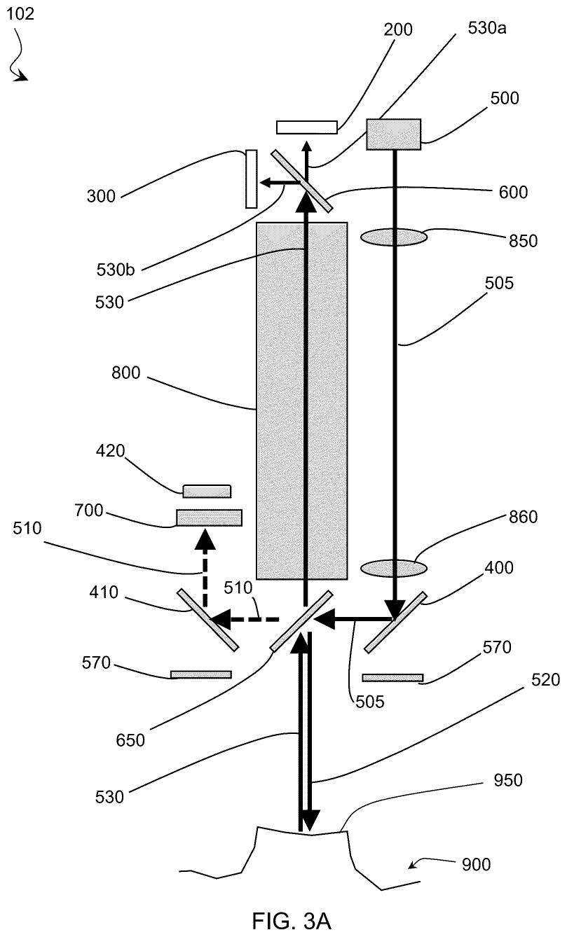

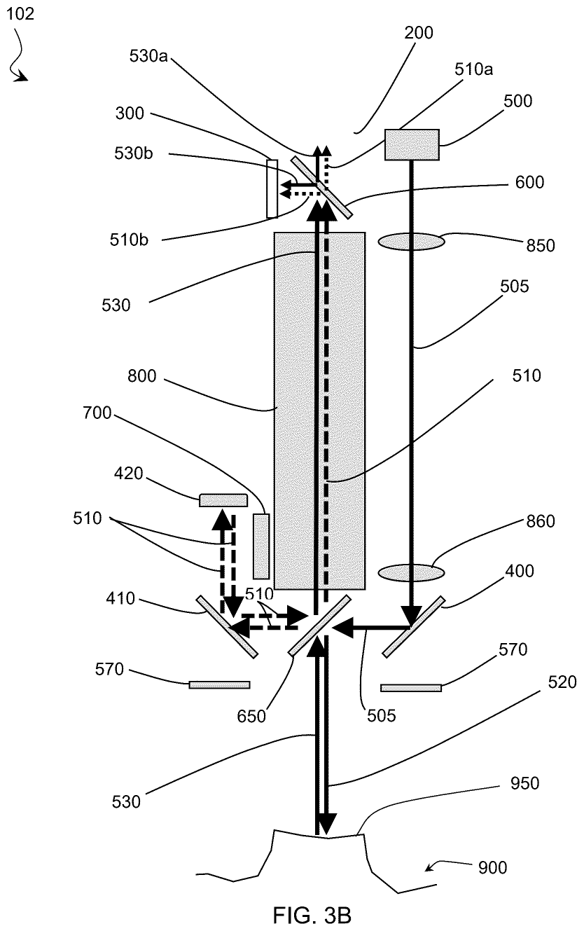

Examples of measurement apparatus configured and arranged forthe imaging by means of parallel optical coherence tomography with dynamic focus can be found in the US patent application US 2008/0024767 A1. In particular, FIGS. 3, 4 and 5, together with the corresponding portions of the description, describe relevant examples of additional embodiments using the pOCT.

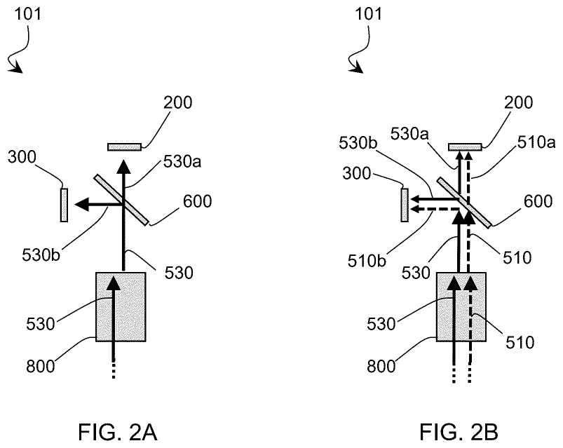

FIG. 2A and 2B show schematically a section of a further embodiment of a measurement apparatus as measurement apparatus 101, which operates in each case in a 2D image capture mode or a 3D image capture mode. They show the portions of the measurement apparatus 101 comprising the first image sensor 200, the second image sensor 300, and the near portion of the imaging lens 800. They are the same as the embodiments illustrated in FIG. 1A and 1B, respectively, except that the first image sensor 200 and the second image sensor 300 are arranged in positions that are substantially fixed with respect to the exit beam of the imaging lens 800. In other words, there is no significant amendment to the arrangement of a first image sensor 200 and a second image sensor 300 if the measurement apparatus 101 switches between the 2D image capture mode and the 3D image capture mode.

In the measurement apparatus 101, in addition, a first light divider 600 is provided, which is configured and arranged to receive the measurement light beam 530 from the imaging lens 800, to direct a first portion 530a of the measurement light beam 530 onto the first image sensor 200 and to direct a second portion 530b of the measurement light beam 530 onto the second image sensor 300.

In addition, the first light divider 600 is configured and arranged to receive the reference light beam 510 from the imaging lens 800 and to transmit at least a significant portion 510b of the reference light beam 510 to the second image sensor 300.

The first light divider 600 may consist of one or more of the following elements: a mirror, a dichroic mirror, a dielectric mirror, a prism, a corner cube, a beam splitter, an optical element, a coating, an optical filter, a compensating plate and/or any combination thereof. The beams are preferably divided into a first portion 510a and a second portion 510b, and a first portion 530a and a second portion 530b, respectively, with an intensity ratio of approximately 50 to 50, in order to optimise the measurement light beam 530 that reaches both the 2D image sensor and the 3D image sensor.

In some configurations, however, it may be advantageous to use light dividers that provide an intensity ratio of the first portion 510a or 530a to the second portion 510b or 530b in a ratio of 40 to 60, 30 to 70, 20 to 80 or 10 to 90. In this context, a significant portion should be understood as a second portion 510b of more than 50% for standard applications with, for example, oxide-coated and thus hardly reflective components as measurement objects and about 10% in the case of special of special system designs for, for example, reflective components as measurement objects of the reference light beam 510, which strikes the first light divider 600, in particular in 3D image capture mode.

If no additional illumination is used except for a low-coherence light source 500, then the first light divider 600 preferably comprises a beam splitter. If an additional illumination light source, e.g. a ring light source, is used, which emits light in other spectral ranges than the low-coherence light source 500, then the first light divider 600 preferably comprises a dichroic mirror.

During operation in a 3D image capture mode as described above with reference to FIG. 2B, the illumination light beam is captured and reflected to the imaging lens 800 in the same manner as described above with reference to FIG. 1B. The returning measurement light beam 530, illustrated by a solid line arrow, is focused on the first image sensor 200 and the second image sensor 300.

Further, the reference light beam 510 is captured and emitted in the direction of the imaging lens 800 in the same manner as described above for FIG. 1B.

The emitted reference light beam 510, represented by a dashed line arrow, is focused on the first image sensor 200 and the second image sensor 300. The first light divider 600 divides the measurement light beam 530 into a first portion 530a and a second portion 530b. The first light divider 600 also divides the reference light beam 510 into a first portion 510a and a second portion 510b. The second image sensor 300 is configured and arranged to receive the second portion 530b of the measurement light beam 530 and the second portion 510b of the reference light beam 510 from the imaging lens 800 and combining the second portion 530b of the measurement light beam 530 and the second portion 510b of the reference light beam 510 on the second image sensor 300, as described above for FIG. 1B. The first image sensor 200 is configured and arranged to receive the first portion 530a of the measurement light beam 530. The first light divider 600 also allows the first portion 510a of the reference light beam 510 from the imaging lens 800 to pass towards the first image sensor 200. This is a consequence of using a first light divider 600, which divides incoming light into two portions.

The operation in a 2D image capture mode, as illustrated in FIG. 2A, is the same as the operation in the 3D image capture mode, as illustrated in FIG. 2B, except that the measurement apparatus 101 is configured and arranged to reduce the intensity of the first portion 510a of the reference light beam 510 received at the first image sensor 200, such that a substantial reduction of at least 80% relative to the first portion 510a of the reference light beam 510 reaching the first image sensor 200 in the 3D image sensing mode is preferentially achievable. A reduction of at least 90%, or better yet, a reduction of 95%, is particularly suitable. This can be implemented as described above with reference to FIG. 1A.

In this embodiment of a measurement apparatus, the operating principle used to substantially reduce the intensity of the reference light beam 510 can be employed as described above with reference to FIG. 1. The embodiment of the measurement apparatus 101 illustrated in FIG. 2A and FIG. 2B respectively allows for the arrangement of one or more beam intensity reducer elements for beam intensity reduction at one or more locations, for example between the first image sensor 200 and the first light divider 600, in the first light divider 600 itself, arranged between the first light divider 600 and the imaging lens 800 and between the imaging lens 800 and the non-depicted second light divider 650 or at any location along the optical path of the reference light beam 510 before the reference light beam 510 enters the imaging lens 800, wherein in the case of a plurality of elements for beam intensity reduction, the arrangement of these elements is possible at all of these locations or only at a portion of these previously enumerated locations.

As described above in relation to FIG. 1, the implementation of the substantial reduction is preferably inserted primarily between the imaging lens 800 and the light source 500 and/or embedded in the light source 500. In particular for the embodiment of

FIG. 2, the optical path from the common region 950 to both the first image sensor 200 and the second image sensor 300 is not substantially changed or disturbed if the measurement apparatus 101 is switched between the 2D image capture mode and the 3D image capture mode. This substantially maps the same field of view in the 2D image capture mode and the 3D imaging mode and allows for a relatively high switching speed between the two modes, e.g. greater than or equal to 1 Hz, which is particularly advantageous for inline measurements.

FIG. 3A and FIG. 3B show a top view of an embodiment of a measurement apparatus as measurement apparatus 102, each operating in a 2D image capture mode or in a 3D image capture mode. This embodiment 102 is similar to the embodiments of a measurement apparatus illustrated in FIG. 2A and FIG. 2B, except that the light emitted from the light source 500 first passes through an optional collimator 850 comprising at least one optical element. The collimator 850 is configured and arranged to provide an approximately parallel light beam 505 from the light source 500. In some configurations, the collimator can be omitted if the light emitted by the source 500 is sufficiently parallel. The approximately parallel light beam 505 then passes through a focusing lens 860 comprising at least one optical element. The focusing lens 860 is configured and arranged to focus the approximately parallel light beam 505 onto the common region 950 of the object 900. As illustrated, an optional first beam deflector 400 is used to deflect the focused parallel light beam 505 onto a second light divider 650. In general, one or more beam deflectors, such as one or more mirrors, can be used to provide a suitable optical path and/or alignment of the components. A second light divider 650 configured and arranged to receive the focused parallel light beam 505 and to divide it into a reference light beam 510, represented by a dashed line arrow, and an illumination light beam 520, represented by a solid line arrow. In other words, the second light divider 650 directs at least a portion of the incoming light 505 to illuminate the common region 950, and the second light divider 650 directs at least another portion of the incoming light 505 into the optical path of the reference light beam 510, which then enters the imaging lens 800.

The second light divider 650 may comprise one or more of the following: a mirror, a dichroic mirror, a dielectric mirror, a prism, a corner cube, a beam splitter, an optical element, a coating, an optical filter, a compensation plate, and any combination thereof. The beam 505 is preferably split into a reference light beam 510 and an illumination light beam 520 with an intensity ratio of approximately 50:50 to optimise the interferometric measurement light beam that reaches the 3D image sensor 300. In some configurations, however, it may be advantageous to use light dividers that provide intensity ratios of 40 to 60, 30 to 70, 20 to 80, or 10 to 90.

Furthermore, the second light divider 650 is configured and arranged to direct the illumination light beam 520 through an opening into or onto the common region 950 of the object 900. In addition or as an alternative, one or more beam deflectors can be used to direct the illumination light beam 520.

The second light divider 650 is also configured and arranged to direct the reference light beam 510 onto a reference mirror 420 for the reference light beam 510, which is used within the apparatus 102. In addition or as an alternative, one or more beam deflectors can be used to direct the reference light beam 510.

As illustrated, an optional second beam deflector 410 is used to deflect the reference light beam 510 onto the reference mirror 420. In general, one or more beam deflectors, such as one or more mirrors, can be used to provide a suitable optical path and/or a suitable alignment of the components.

The reference mirror 420 is configured and arranged so that the reference light beam 510 is reflected back in the direction of the second light divider 650. In addition, one or more beam deflectors can be used to redirect the reference light beam 510. As illustrated, the optional second beam deflector 410 is also used to deflect the reference light beam 510 back to the second light divider 650.

Furthermore, the reference mirror 420 is configured and arranged such that it can be moved in the axial direction during the 3D image capture process such that the length of the optical path from the second light divider to the focal plane of the common region 950 is substantially equal to the length of the optical path from the second light divider 650 to the reference mirror 420.

This embodiment of the measurement apparatus 102 is comprising a beam intensity reducer 700, such as a stop, a shutter, a mechanical iris, a mirror, a dichroic mirror, a dielectric mirror, a prism, a corner cube, beam splitter, lens element, coating, optical filter, compensating plate, and/or any combination thereof, configured and arranged to substantially reduce the intensity of the reference light beam 510. As illustrated in FIG. 3A, during 2D measurement, the beam intensity reducer 700 can be inserted in the optical path of the reference light beam 510 immediately before the reference mirror 420, thereby reducing or preventing reflection from the reference mirror 420 back to the second light divider 650. The beam intensity reducer 700 is preferably highly optically absorbing to the light emitted by the light source 500. As illustrated in FIG. 3B, the beam intensity reducer 700 can be used outside the optical path of the reference light beam 510 during 3D image capture, thereby allowing for reflection from the reference mirror 420 back to the second light divider 650.

The beam intensity reducer 700 can be included, for example, in a linear actuator, in a rotatable actuator (as schematically illustrated in FIG. 3A and FIG. 3B), in a rotatable turret, or in any combination thereof.

Furthermore, the second light divider 650 is configured and arranged to direct the reference light beam 510 reflected back from the reference mirror 420 into the imaging lens 800. The second light divider 650 is also configured and arranged to direct the measurement light beam 530 reflected back from the common region 950 into the imaging lens 800. Optionally, the second light divider 650 can also be configured and arranged to combine the reference light beam 510 reflected by the reference mirror 420 and the measurement light beam 530 reflected by the common region 950.

During operation in a 3D image capture mode, as illustrated in FIG. 3B, the light emitted by the light source 500 is collimated by the optional collimator 850, preferably in the form of a lens, to provide an approximately parallel beam 505. The approximately parallel beam 505 is focused on the common region 950 using the focusing lens 860. After passing through the focusing lens 860, the nearly parallel beam 505 is deflected onto the second light divider 650 using the first beam deflector 400.

In this exemplary embodiment of the measurement apparatus 102, the second light divider 650 divides the approximately parallel beam 505 into an illumination light beam 520, which it also directs onto the common region 950 of the object, and a reference light beam 510, which it also directs onto the reference mirror 420 using the second beam deflector 410. The focused illumination light beam 520 is reflected back from the common region 950 to the second light divider 650 as a measurement light beam 530. Additionally, illumination sources 570 can be provided for the object, such as one or more ring lights. The reference light beam 510, represented as a dashed arrow, is deflected by the second beam deflector 410 onto the reference mirror 420, where the reference light beam 510, represented as a dashed arrow, is reflected back via the second beam deflector 410 to the second light divider 650. The beam intensity reducer 700 is illustrated in the open state so that it does not substantially intersect the reference light beam 510 when approaching the reference mirror 420 or when reflecting to the second light divider 650.

The axial position of the reference mirror 420 is predetermined and/or controlled so that in 3D image capture, the length of the optical path from the second light divider to the focal plane of the common region 950 is substantially equal to the length of the optical path from the second light divider 650 to the reference mirror 420. In addition, during axial or vertical scanning, additional axial moving of the reference mirror 420 may be required to substantially uphold the optical path lengths.

In this exemplary embodiment of the measurement apparatus 102, the second light divider 650 combines the reference light beam 510 reflected back from the reference mirror 420 and the returning measurement light beam 530. The combined beam is directed into the imaging lens 800. The combined returning measurement light beam 530, illustrated by the solid arrow, and the reference light beam 510, illustrated by the dashed arrow, are focused and directed through the iv 800 and the first light divider 600 onto the first imaging sensor 200 and the second imaging sensor 300, as described above with reference to FIG. 2B.

The operation in a 2D image capture mode, as illustrated in FIG. 3A, is the same as the operation in the 3D image capture mode, as illustrated in FIG. 3B, except that the beam intensity reducer 700 is moved to its closed state, thereby substantially reducing the intensity of the first portion 510a of the reference light beam 510 received at the first image sensor 200. In particular, the intensity of the reference light beam 510 reaching the reference mirror 420 is significantly reduced, thereby also significantly reducing the reference light beam 510 reflected back towards the second light divider 650.

Consequently, the light reaching the first image sensor 200 and the light reaching the second image sensor 300 comprises substantially the same measurement light beam 530 as in the 3D image capture mode and an at least substantially reduced reference light beam 510. Preferably, the intensity of the reference light beam 510 is reduced such that it does not substantially influence the 2D image capture at the first image sensor 200, and even more preferably such that it is substantially not detectable at the first image sensor 200. The term not substantially means here that the intensity of the reduced reference light beam 510 is below a possibly predetermined intensity value of the image sensor.

The present description is not to be understood as prescribing a fixed order for the pass-through of the method steps described therein. Rather, the method steps can be carried out in any order that is practical. Similarly, the examples serve to explain the algorithm and are not intended to represent the only implementations of these algorithms. Those skilled in the art will be able to think of many different ways to achieve the same functionality as provided by the present embodiments.

For example, the first light divider 600 of the measurement apparatus 101, as illustrated in FIG. 2A and FIG. 2B, may alternatively comprise a displaceable and/or rotatable mirror. The measurement apparatus 101 may then be configured and arranged to utilise the first light divider 600 in a first and a second arrangement and/or rotation corresponding to an orientation to direct light onto the first image sensor 200 and the second image sensor 300. For example, the first light divider 600 may comprise a suitably configured linear actuator, a rotating actuator or the like.

This is also possible, for example, for the first light divider 600 of the measurement apparatus 102, as illustrated in FIG. 3A and FIG. 3B, so that it can alternatively comprise a displaceable and/or rotatable mirror. The measurement apparatus 102 may then be configured and arranged to utilise the first light divider 600 in a first and a second arrangement and/or rotation corresponding to an orientation to direct light onto the first image sensor 200 and the second image sensor 300. For example, the first light divider 600 may comprise a suitably configured linear actuator, a rotating actuator or the like.

For example, the second image sensor 300 in FIG. 3A and FIG. 3B is illustrated in the top view as being to the left of the first light divider 600. Alternatively, the first light divider 600 is formed and arranged such that the second image sensor 300 is attached behind, above or in a lateral arrangement position, in this case on the right with reference to FIG. 3A and FIG. 3B, in the top view.

In order to correct, for example, the low reflection from the common region 950 to a certain extent, the intensity of the reference light beam 510 can be reduced when operating in a 3D image capture mode by changing one or more of the measures implemented to substantially reduce the intensity during a 2D image capture mode. For example, a neutral density filter may be located at a suitable point in the optical path of the reference light beam 510.

The present embodiments of a measurement apparatus 100, 101, 102 according to the above considerations allow for a relatively high measurement throughput in a relatively small assembly volume.

The present embodiments of a measurement apparatus 100, 101, 102 according to the above considerations can preferably be a portion of an image capture system as used in inline manufacturing.

Typically, such an image capture system is used in a manufacturing system for picking and placing an object 900 in the form of a component on a substrate. Such a manufacturing system comprises a pick-and-place head with at least one tool, such as a nozzle, which can preferably be subjected to a vacuum in order to grip the object 900 and/or uphold it in a releasable manner.

Furthermore, such a manufacturing system is comprised of a robot system for capturing a relative movement of the pick-and-place head between a pick-up position of an object 900 for picking up an object located there with a pick-up device and the substrate on which an object picked up by means of the pick-up device can be placed.

Preferably in such a manufacturing system, the image capture system is arranged to capture at least one of an image of a location on the substrate to be placed with the object 900, and an image of the surface of the object 900, or any other common region 950 within one or more fields of view, wherein the image capture system comprises one or more measurement apparatuses 100, 101, 102 according to the above considerations.

The present embodiments of a measurement apparatus 100, 101, 102 according to the preceding disclosure can therefore preferably also be a portion of an image capture system used in inline inspection. Typically, such an image capture system is used in an inspection system for capturing one or more fields of view of an object 900 to be inspected or one or more fields of view of a substrate to be inspected. Typically, in such an inspection system, the image capture system comprises one or more measurement apparatuses 100, 101, 102, as well as a processor that is formed and arranged such that it determines and/or derives one or more measurement values of the object 900 to be inspected or of the substrate to be inspected from the one or more fields of view from the captured data. Furthermore, the processor is formed in such a way that it can determine from the one or more measured values whether there is a defect in the form of a defect or a deviation from a nominal value of the object 900 or substrate to be inspected, so that a surface analysis as such of the substrate or object is also possible. Such defects may, for example, be surface damage in the form of chips, scratches or imperfections, or damaged or misplaced components.

Although the present invention has been described in the context of certain exemplary embodiments, it should be understood that various amendments, substitutions and modifications, which are obvious to those skilled in the art, may be made to the disclosed embodiments without departing from the spirit and scope of the invention as set forth in the appended claims.

LIST OF NUMERALS

| | |
|---|---|
| 100 | embodiment of a measurement apparatus |
| 101 | embodiment of a measurement apparatus |
| 102 | embodiment of a measurement apparatus |
| 200 | first image sensor for 2D-Measurement |
| 300 | second image sensor for 3D-Measurement |
| 400 | first beam deflector |
| 410 | second beam deflector |
| 420 | reference mirror |
| 500 | light source |
| 505 | approximately parallel light beam emitted by the source |
| 510 | reference light beam |
| 510a | first portion of a beam |
| 510b | second portion of a beam |
| 520 | illumination light beam |
| 530 | measurement light beam |
| 530a | first portion of a beam |
| 530b | second portion of a beam |
| 570 | illumination source |
| 600 | first light divider |
| 650 | second light divider |
| 700 | beam intensity reducer |
| 800 | imaging lense |
| 850 | collimator |
| 860 | focusing lense |
| 900 | object in form of a component |
| 950 | common region of an object |

1. Measurement apparatus (100, 101, 102) comprising a first imaging sensor (200) for 2D imaging and a second imaging sensor (300) for 3D imaging, wherein the measurement apparatus (100, 101, 102) is configured and arranged to be focused on a common region (950) of an object (900), wherein the measurement apparatus (100, 101, 102) additionally comprising:
a light source (500) that is configured and arranged to emit, in use, an illumination light beam (520) onto the common region (950), and the light source (500) is further configured and arranged to emit a reference light beam (510) onto the second imaging sensor (300);
an imaging lens (800) comprising at least one optical element arranged so that, in use, light that is reflected from the common region (950) as a measurement light beam (530) enters the imaging lens (800) together with the reference light beam (510) of the light source (500) enters the imaging lens (800), wherein the imaging lens (800) is additionally formed and arranged to
direct and focus at least a first portion (530a) of the measurement light beam (530) onto the first imaging sensor (200); and/or
direct at least a second portion (530b) of the measurement light beam (530) and a second portion (510b) of the reference light beam (510) onto the second imaging sensor (300) and focusing them;
and the measurement apparatus (100, 101, 102) is formed and arranged to reduce or extinguish the intensity of a first portion (510a) of the reference light beam (510) receivable at the first imaging sensor (200) (510) when the measurement apparatus (100, 101, 102) is operated in a 2D imaging mode.

2. Measurement apparatus (100, 101, 102) according to claim 1, wherein the first imaging sensor (200) is a 2D imaging sensor and the second imaging sensor (300) is a 3D imaging sensor.

3. Measurement apparatus (100, 101, 102) according to claim 1, wherein the first imaging sensor (200) is a 3D imaging sensor and the second imaging sensor (300) is a 3D imaging sensor, wherein the imaging sensor (200) is formed and arranged such that the imaging sensor (200) is operable in a 2D imaging mode.

4. Measurement apparatus (100, 101, 102) according to claim 1, which is furthermore so formed and arranged as to transmit at least the second portion (510b) of the reference light beam (510) from the object iv (800) in the direction of the second imaging sensor (300) if the measurement apparatus (100, 101, 102) is operated in a 3D imaging mode.

5. Measurement apparatus (100, 101, 102) according to claim 1, wherein the measurement apparatus (100, 101, 102) is formed and arranged such that the intensity of the reference light beam (510) is reducible along the optical path of the reference light beam (510), preferably between the imaging lens (800) and the light source (500).

6. Measurement apparatus (100, 101, 102) according to claim 1, wherein the measurement apparatus (100, 101, 102) is formed and arranged such that the intensity of the reference light beam (510) in the light source (500) is reducible.

7. Measurement apparatus (100, 101, 102) according to claim 1, wherein the measurement apparatus (100, 101, 102) includes a beam intensity reducer (700) in the form of one or more of the following elements, namely an diaphragm, a shutter, a mechanical iris, a mirror, a dichroic mirror, a dielectric mirror, a prism, a corner cube, a beam splitter, a lens element, a coating, an optical filter, a compensation plate, or any combination thereof, each formed and arranged such that the intensity of the first portion (510a) of the reference light beam (510) receivable by the first imaging sensor (200) is reducible therewith in operation in 2D imaging mode.

8. Measurement apparatus (100, 101, 102) according to claim 1, wherein the measurement apparatus (100, 101, 102) further comprises a first light divider (600) that is formed and arranged such that the measurement light beam (530) can be received by the imaging lens (800) and that the first portion (530a) of the measurement light beam (530) can be directed onto the first imaging sensor (200) and/or the second portion (530b) of the measurement light beam (530) can be directed onto the second imaging sensor (300).

9. Measurement apparatus (100, 101, 102) according to claim 7, wherein the first light divider (600) is also formed and arranged such that, in operation in a 3D imaging mode, the reference light beam (510) is receivable by the imaging lens (800) and that at least the second portion (510b) of the reference light beam (510) is transmissible in the direction of the second imaging sensor (300).

10. Measurement apparatus (100, 101, 102) according to claim 7, wherein the first light divider (600) comprises one or more of the following: a mirror, a dichroic dielectric mirror, prism, corner cube, beam splitter, optical element, coating, optical filter, compensating plate, and/or any combination thereof.

11. Measurement apparatus (100, 101, 102) according to claim 1, wherein the imaging lens (800) comprises one or more compound lenses.

12. Measurement apparatus (100, 101, 102) according to claim 1, wherein the imaging lens (800) is a telecentric imaging lens.

13. Measurement apparatus (100, 101, 102) according to claim 1, wherein the measurement apparatus (100, 101, 102) is formed and arranged such that it provides one or more fields of view of the common region (950) of the object (900).

14. Measurement apparatus (100, 101, 102) according to claim 1, wherein the measurement apparatus (100, 101, 102) further comprises a second light divider (650) formed and arranged such that, in operation in a 3D imaging mode, an incoming light beam (505) from the light source (500) and at least a portion of the incident light beam (505) is directable as an illumination light beam (520) onto the common region (950), and at least a portion of the incident light (505) is directable as a reference light beam (510) onto the imaging lens (800).

15. Measurement apparatus (100, 101, 102) according to claim 1, wherein the measurement apparatus (100, 101, 102) is configured and arranged to be operable in a 3D imaging mode such as white-light interferometry, optical coherence tomography (OCT), parallel optical coherence tomography (pOCT), or any combination thereof.

16. Manufacturing system for sorting objects (900) and/or for picking-and-placing an object (900) on a substrate, wherein the manufacturing system comprises the following:
at least one pick-and-place head with at least one tool each for upholding the object (900) in a releasable manner;
robot system for capturing a relative movement of the pick-and-place head between a receiving position for an object (900) and the substrate; and
an image capture system for capturing one or more common regions (950) of the object (900) to be captured, wherein the image capture system comprises one or more measurement apparatuses (100, 101, 102) according to claim 1.

17. Inspection system comprising:
an image capture system for capturing one or more fields of view of an object (900) to be inspected: and
a processor that is formed and arranged such that it derives one or more measured values of the object (900) to be inspected from the one or more fields of view, wherein the processor can be used to determine from the one or more measured values whether a fault in the form of a defect or a deviation from a nominal size has occurred in the object (900) to be inspected,
wherein the image capture system comprises one or more measurement apparatuses (100, 101, 102) according to claim 1.
